(19) United States
(12) Patent Application Publication
(10) Pub. No.: US 2006/0061896 A1
(43) Pub. Date: Mar. 23, 2006

(54) Device for mixing of colored lights using a rotating disk

(76) Inventors: Lyudmila Belousova, Saint Louis, MO (US); Julia Viseysky, Saint Louis, MO (US)

Correspondence Address: Ms. Lyudmila Belousova, 808 Coalport Dr., Saint Louis, MO, 63141, US

(21) Appl. No.: 10/946,824

(22) Filed: Sep. 23, 2004

(51) Int. Cl. G02B 5/32

(52) U.S. Cl. 359/892; 310/254

(57) ABSTRACT

Device for mixing of colored lights includes a rotating disk having circular sectors of color filters. The disk rotates without use of an electromotor. In order the disk to rotate, the disk is mounted in an inner mobile metallic, for example aluminum, ring of a ball-bearing, wherein balls, separators and an outer fixed ring are electric insulators. The diameter of the disk is close to the diameter of the inner ring. The disk rotates together with the inner ring, which is rotated by a rotating magnetic field. The field is created by an inductor-stator, when the inductor-stator is supplied by polyphase alternating electrical current. When the disk rotates and one side of the disk is illuminated by a white light, while a motionless white screen is placed in front of the other side of the disk, a circle with rotating color sectors appears on the screen. Sectors on the screen and sectors on the disk rotate, simultaneously, and, if the disk rotates rapidly, colors of rotating sectors on the screen are added in eye, and observers see an uniform color circle on the screen instead of circle with color sectors.

### BACKGROUND OF THE INVENTION

The present invention relates to optics, to color perception and, particularly, to a device for mixing of colored lights using a rotating disk.

It is known a device for mixing of colored lights using an opaque rotating Maxwell disk, which sectors are painted in different colors. (See, for example, Judd, D. and Wyszecky, G. “Color in Business, Science and Industry”, 3^{rd} Edition, John Wiley & Sons, New York 1975). When the disk is rotated rapidly, the colors are added in eye and observers see the disk as a circle of a uniform color. The disk is mounted on the shaft, which is usually rotated by an electromotor.

However, the uniform color of the disk, which is rotated rapidly, can differ from the expected uniform color, because paints have pigments, and colors of painted sectors differ from pure spectrum colors. Therefore, it is a problem: to replace the rotating disk having opaque painted sectors by rotating disk having sectors of color filters. Another problem is related to using the disk having sectors of color filters mounted on the shaft rotated by the electromotor. Because the electromotor and its support create obstacles on the way of the luminous flux for illumination of color filters.

### BRIEF SUMMARY OF THE INVENTION

An object of present invention is a device for mixing of colored lights using a rotating disk, and in the device the rotating disk having sectors of color filters rotates without use of an electromotor. The mixing of colored lights can be observed on a motionless white screen wherein color sectors rotate simultaneously with sectors of color filters on the rotating disk.

In order to achieve the above object, the device for mixing of colored lights using a rotating disk includes a housing, a rotating disk having circular sectors of color filters, a ball-bearing and an inductor—stator. The disk, the ball-bearing and the inductor—stator are placed within housing. A screen is placed out of the housing, in front of one side of the disk, while other side of the disk is illuminated by a white light. The screen parallels the disk. The screen is preferably motionless white screen.

The disk is mounted in an inner mobile metallic, for example aluminum, ring of the ball-bearing having balls, separators and an outer fixed ring of electro-insulating material or materials. The disk rotates together with the inner ring. The axis of rotation of the disk coincides with the axis of rotation of the inner ring, which is rotated by a rotating magnetic field. The rotating magnetic field is created by the inductor-stator, when the inductor-stator is supplied by polyphase alternating current. The inductor-stator is placed between the outer ring and the housing. The outer ring is mounted to the inductor-stator, whose base is mounted to the housing. The housing is preferably a cylindrical housing.

When the disk rotates, the mixing of colored lights can be observed on the motionless white screen, wherein color sectors rotate simultaneously with sectors of color filters on the rotating disk.

In one embodiment of the invention, the inductor-stator includes an even number of identical coils that are supplied by polyphase alternating current Said coils are placed regularly along a circumference of the outer ring of the ball-bearing so that the axis of each coil is directed along a radius to the center of the circumference. Said coils are mounted on teeth protruing from the base of the inductor-stator.

In another embodiment of the invention, one or both ends of said housing are covered by protective glasses that are mounted to said housing.

In yet another embodiment of the invention, said disk has a central round opening, and, instead of said circular sectors of color filter, said disk includes circular ring sectors of color filters.

The present invention has the following advantages:

The present invention includes a rotating disk having sectors of color filters instead of a rotating disk having opaque painted sectors.

In present invention the mixing of colored lights can be observed on a motionless white screen, wherein color sectors rotate simultaneously with sectors of color filters on the rotating disk.

In present invention the disk rotates without use of an electromotor. The disk is mounted in an inner mobile metallic ring of a ball-bearing, wherein balls, separators and an outer fixed ring are electric insulators. The disk rotates together with the inner ring, and the inner ring is rotated by the way of electromagnectic induction.

The present invention can be used in classroom, as visual aid for illustration of color addition by the mixing of colored lights. The invention can be used for investigation of color perception, and for decorative light effects.

### BRIEF DESCRIPTION OF THE DRAWING FIGURES

FIG. 1 is a general view of a device for mixing of colored lights using a rotating disk in accordance with the present invention;

FIG. 2 is a side sectional view of the device shown in FIG. 1. (In FIG. 2 the screen not shown); and

FIG. 3 is cross-sectional view of the device taken along line 2-2 shown in FIG. 2.

### DETAILED DESCRIPTION OF INVENTION

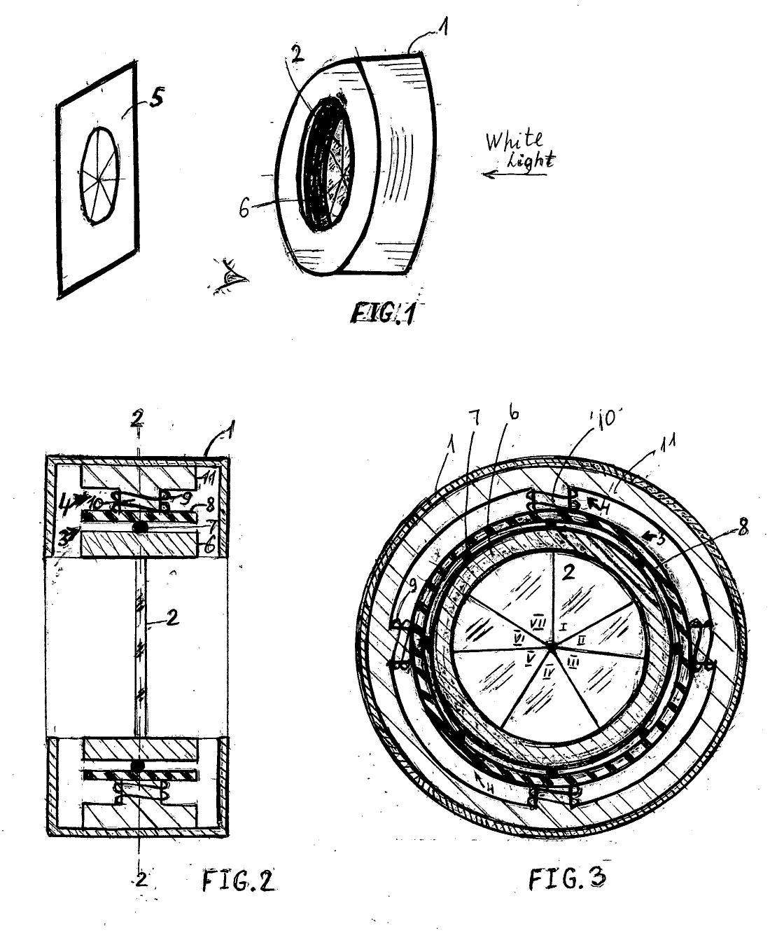

A preferred embodiment of device for mixing of colored lights using a rotating disk in accordance with the present invention is illustrated in FIG. 1-FIG. 3.

The device includes a cylindrical housing 1, a rotating disk 2 having circular sectors of color filters, a ball-bearing 3 and an inductor-stator 4. The disk 2, the ball-bearing 3 and the inductor-stator 4 are placed within the housing. A motionless white screen 5 is placed out of the housing 1, in front of one side of the disk 2, while the other side of the disk 2 is illuminated by a white light. The screen 5 parallels the disk 2. The disk 2 is mounted in an inner mobile metallic, for example aluminum, ring 6 of the ball-bearing 3 with balls 7, separators (not shown) and with an outer fixed ring 8. The axis of rotation of the ring 6 coincides with axis of rotation of the disk 2. The diameter of the disk 2 is preferably close to the diameter of the ring 6. Balls 7, separators and the ring 8 are electric insulators. Balls 7 and separators are preferably small, and the ring 8 is preferably thin.

The inner ring 6 is rotated by a rotating magnetic field which is created by the inductor-stator 4. The disk 2 rotates together with the ring 6. The inductor-stator 4 is placed between the ring 8 and the housing 1.

In order to prevent occurrence of induction current in balls 7, in separators and in the ring 8 by a rotating magnetic field, ball separators and fixed ring must be made of electro-insulating materials, for example of plastic, ceramic, wood or glass.

A small diameter of balls 7, a small size of separators and a small thickness of the ring 8 are preferred to keep the distance between the inductor-stator 4 and the ring 6 to a minimum.

The inductor-stator 4 includes an even number of identical coils 9 that are placed regularly along a circumference of the outer ring 8 and the axis of each coil 9 directs along a radius to the center of the circumference. The coils 9 are mounted on the teeth 10 that protrude from a base 11 of the inductor-stator 4, wherein the base 11 and the teeth 10 can be made of a metal such as iron. The base 11 is mounted to the housing 1. The ring 8 is mounted to the inductor-stator 4 to the ends of the teeth 10 (see FIG. 2-FIG. 3).

In drawing figures is shown inductor-stator 4 for polyphase, particularly, two phase alternating current with phase angle 90°. The inductor-stator 4 includes four identical coils 9 which are placed as is shown in FIG. 3. Each coil 9 is consequently connected with another coil (its pair), which is placed on diametrically opposite end.

The device works so that when coils 9 are supplied by polyphase alternating current, a rotating magnetic field arises and makes an induction-current into metalic ring 6. As result of the interaction between the magnetic field of induction-current into the ring 6 and the rotating magnetic field, the ring 6 rotates. The disk having sectors of color filters rotates together with the ring 6, because the disk 2 is mounted in the ring 6. Then, if one side of rotating disk 2 is illuminated by white light, a circle with rotating color sectors appears on a motionless white screen 5 which is placed in front of the other side of the disk 2. Sectors on the screen 5 correspond to sectors of color filters on the disk 2, and sectors on the screen 5 rotate simultaneously with sectors on the disk 2. When the disk 2 is rotated rapidly, colors of the rotating sectors on the screen 5 are added in eye and observers see an uniform color circle, instead of the circle with color sectors.

For example, observers see an uniform white circle on the screen 5, when the disk 2 is rotated rapidly and has sectors of color filters whose colors correspond to colors of the rainbow: red (I), orange (II), yellow (III), green (IY), blue (Y), indigo (YI), and violet (YII) (see FIG. 3). In FIG. 3 areas of color sectors correspond to produce of white light.

The direction of rotation of the ring 6 together with the disk 2 coincides with direction of rotation of the rotating magnetic field which produces rotation of the ring 6. The speed of rotation of the ring 6 is always below than the speed of rotation of the field. The speed of rotation of the field, as known, is proportional to the frequency of alternating current in coils 9, and inversely proportional to the number of coils 9, that constructed on the base 11 of inductor-stator 4. In case, when stator-inductor 4 has four coils 9 (see FIG. 2 and FIG. 3) the speed of rotation of the field is 1800 rpm (revolution per minute) for 60 Hz frequency of current. The speed of rotation of the disk 2 is below than 1800 rpm.

The disk 2 rotates rapidly, if the time of one revolution of the disk is not more than the time of survive of vision perception in eye, i.e. the time of inertia of eyesight

The time of survival of a vision perception in the eye is close to 0.1 sec. Consequently, the disk 2 rotated rapidly when the time of one revolution of the disk 2 is not more than 0.1 sec, that corresponds to the speed of rotation which is not less than 600 rpm.

What is claim is:

1. Device for mixing colored lights using a rotating disk comprising:
a housing;
a rotating disk having circular sectors of color filters is placed within said housing;
a ball-bearing having an inner mobile metallic ring, and having balls, separators and an outer fixed ring of electro-insulating material or materials, and said ball-bearing is placed within said housing, and said disk is mounted in said inner ring so, that the axis of rotation of said disk coincides with axis of rotation of said inner ring, and said disk rotates together with said inner ring, which is rotated by a rotating magnetic field;
an inductor-stator which produces said rotating magnetic field, when said inductor-stator is supplied by polyphase alternating current, and said inductor-stator is placed between said outer ring of said ball-bearing and said housing, and said outer ring is mounted to said inductor-stator, whose base is mounted to said housing; and
a screen which is placed out of said housing, in front of one side of said disk, while the other side of said disk is illuminated by white light, and said screen parallels said disk, and, when said disk rotates, mixing of colored lights can be observed on said screen, wherein color sectors rotate simultaneously with sectors of color filters on said disk.

2. Device as in claim 1, wherein said housing is a cylindrical housing.

3. Device as in claim 2, wherein said inductor-stator includes an even number of identical coils that are supplied by polyphase alternating current, and said coils are placed regularly along a circumference of said outer ring of said ball-bearing so that the axis of each coil is directed along a radius to the center of said circumference, and said coils are mounted on teeth protruding from said base of said inductor-stator.

4. Device as in claim 3,wherein said base and said teeth of said inductor-stator are iron base and iron teeth.

5. Device as in claim 2, wherein one or both ends of said housing are covered by protective glasses that are mounted to said housing.

6. Device as in claim 1, wherein said screen is a motionless white screen.

7. Device as in claim 1, wherein said disk has a central round opening, and, instead of said circular sectors of color filters, said disk includes circular ring sectors of color filters.
